(19) United States
(12) Patent Application Publication
(10) Pub. No.: US 2010/0141450 A1
(43) Pub. Date: Jun. 10, 2010

(54) APPARATUS FOR COMMUNICATING WITH RFID TAG

(75) Inventor: Takuya NAGAI, Aichi (JP)

Correspondence Address: DAY PITNEY LLP, 7 TIMES SQUARE, NEW YORK, NY, 10036-7311, US

(73) Assignee: Brother Kogyo Kabushiki Kaisha, Aichi (JP)

(21) Appl. No.: 12/708,031

(22) Filed: Feb. 18, 2010

Related U.S. Application Data
(63) Continuation-in-part of application No. PCT/JP2008/064472, filed on Aug. 12, 2008.

(30) Foreign Application Priority Data
Sep. 12, 2007 (JP) 2007-236306

(51) Int. Cl. G08B 13/22; G06K 7/01

(52) U.S. Cl. 340/572.1; 340/10.41

(57) ABSTRACT

This disclosure discloses an apparatus for communicating with an RFID tag comprising: a radio communication device configured to conduct radio communication with a plurality of RFID tag circuit elements, the RFID circuit element having an IC circuit part and a tag antenna; an information obtaining portion configured to specify identification information of at least one said RFID tag circuit element to be searched and to conduct communication for search through said radio communication device so as to obtain information from said IC circuit part of said RFID tag circuit element thus specified; and a position detection portion configured to conduct communication for position detection through said radio communication device with the specific RFID tag circuit element whose information was obtained by said information obtaining portion and to detect a position of the specified RFID tag circuit element on the basis of a communication result.

### CROSS-REFERENCE TO RELATED APPLICATION

This is a CIP application PCT/JP2008/64472, filed Aug. 12, 2008, which was not published under PCT article 21(2) in English.

### BACKGROUND OF THE INVENTION

1. Field of the Invention

The present invention relates to an apparatus for communicating with a radio frequency identification (RFID) tag configured to conduct information transmission and reception via radio communication with an RFID tag capable of communication with the outside.

2. Description of the Related Art

In the case of article management, an RFID tag is disposed on an article to be managed, and an apparatus for communicating with an RFID tag that reads information held therein in a non-contact manner is already known. A system provided with the apparatus for communicating with an RFID tag is referred to as a Radio Frequency Identification (hereinafter referred to as RFID) system.

In this system, an RFID tag circuit element is disposed in a label-shaped RFID tag for example. This RFID tag circuit element is provided with an IC circuit part storing predetermined RFID tag information and a tag antenna connected to the IC circuit part for conducting information transmission and reception. Even if the RFID tag is stained or arranged in a hidden position, reading and writing of RFID tag information with respect to the IC circuit part is capable with an apparatus antenna of the apparatus for communicating with an RFID tag. The RFID system has been already put into practice in various fields.

Prior art references regarding position detection executed in article management using such an RFID system have been already known. In this prior art reference, an RFID tag circuit element for book is disposed in each of books to become position detection targets, while an RFID tag circuit element for shelf for giving position information is disposed in each shelf of a bookcase. A handheld reading device used by an administrator of the books reads first tag identification information of the RFID tag circuit element for book disposed on each book in the bookcase sequentially from one side to the other side of the shelf. After that, when the reading reaches the end of the shelf, the reading device reads second tag identification information of the RFID tag circuit element for shelf. Then, these two types of tag identification information are both transmitted from the reading device to an operation terminal via radio communication. After that, the operation terminal associates the first tag identification information with the second tag identification information transmitted from the reading device as above through an appropriate operation by the administrator. As a result, book information such as names and contents of the books are associated with shelf information as position information of the book and stored in a database.

In the above prior art reference, if an operator wants to know a storage position of a book, the following operation is needed. That is, the operator accesses the database using the name of the book, for example, as a key using a terminal for operation. By means of this access, the first tag identification information of the RFID tag circuit element for book and moreover, the second tag identification information of the RFID tag circuit element for shelf corresponding to that are obtained. After that, when the operator performs an appropriate operation in the terminal for operation, the two pieces of the tag identification information are both transferred to a handheld reading device via radio communication. The handheld reading device displays a location of the corresponding bookcase by a display device on the basis of the transferred second tag identification information. By means of this display, the reading device guides the operator to a front of the bookcase. The reading device reads the second tag identification information from the RFID tag circuit element for shelf of the bookcase guided as above, and the operator confirms that the bookcase is a correct one by a reading result. After that, the operator specifies the first tag identification information corresponding to the book to be searched to the reading device. The reading device searches it for each shelf of the bookcase on the basis of the specification of the first tag identification information. If the RFID tag circuit element for book provided with the first tag identification information is found, the reading device makes corresponding position display. As a result, the operator can know where the book to be searched is.

As described above, the operation needs extremely cumbersome procedures such as input of the name of the book in the terminal for operation by the operator, transfer of the tag identification information in the handheld reading device, movement of the operator according to the bookcase display, confirmation by the operator on the basis of the reading result of the second tag identification information, and search for each shelf of the bookcase by the reading device using the first tag identification information. In order to avoid this, there can be a method of position detection by directly searching the RFID tag circuit element for book without using the RFID tag circuit element for shelf. However, in this case, reading is executed one by one for each of the RFID tag circuit elements for book of the large number of books arranged on a plurality of shelves in a plurality of bookcases. It takes a very long time to perform position detection of the targeted RFID tag circuit element for book as above, which is poor in efficiency. Particularly, if there are several books to be searched, the same work needs to be repeated for the number of the books, which is poorer in efficiency.

### SUMMARY OF THE INVENTION

The present invention has an object to provide an apparatus for communicating with an RFID tag that can perform position detection of a plurality of RFID tag circuit elements to be searched with efficiency in a short time.

### Means for Solving the Problem

An apparatus for communicating with an RFID tag comprises a radio communication device configured to conduct radio communication with a plurality of RFID tag circuit elements, the RFID circuit element having an IC circuit part storing information and a tag antenna capable of transmission and reception of the information, an information obtaining portion configured to specify identification information of at least one RFID tag circuit element to be searched and to conduct communication for search through the radio communication device so as to obtain information from the IC circuit part of the RFID tag circuit element thus specified, and a position detection portion configured to conduct communication for position detection through the radio communication device with the specific RFID tag circuit element whose information was obtained by the information obtaining portion and to detect a position of the specified RFID tag circuit element on the basis of a communication result of the communication for position.

### BRIEF DESCRIPTION OF THE DRAWING

FIG. 1 is a diagram illustrating an example in which the present invention is applied to management of book materials stored in a cabinet;

FIG. 2 is a system configuration diagram illustrating an outline of a reader according to an embodiment of the present invention;

FIG. 3 is a plan view illustrating an entire appearance of the reader;

FIG. 4 is a functional block diagram illustrating a detailed configuration of a CPU, a radio frequency (RF) communication control part, and a reader antenna in the reader;

FIG. 5 is a block diagram illustrating an example of a functional configuration of an RFID tag circuit element disposed in an RFID tag;

FIG. 6 is a diagram illustrating an example of a time chart of a signal transmitted and received between the reader and the single RFID tag;

FIG. 7A is a table conceptually illustrating a registration tag list that manages tag IDs and material names of the book materials in association with each other;

FIG. 7B is a table conceptually illustrating a detection tag list created from the registration tag list;

FIG. 8 is a flowchart illustrating a control procedure executed by the CPU of the reader when a plural tag detection function is selected;

FIG. 9 is a flowchart illustrating a detailed procedure of a single tag detection mode executed at Step S100 in FIG. 8;

FIG. 10A is a diagram illustrating a display example of a liquid crystal panel at the time when the detection tag list is being created in a state before the processing shown in FIG. 8 is executed;

FIG. 10B is a diagram illustrating a display example of the liquid crystal panel at the time when three RFID tags are specified as targets in the created detection tag list and procedures at Step S20 to Step S50 are executed; and

FIG. 10C is a diagram illustrating a display example of a case in which any of the three RFID tags is found during execution of a plural tag detection mode, the mode is switched to the single tag detection mode and position detection of the RFID tag is being performed.

### DETAILED DESCRIPTION OF THE PREFERRED EMBODIMENTS

An embodiment of the present invention will be described below referring to the attached drawings. This embodiment is an example in which an apparatus for communicating with an RFID tag of the present invention is applied to management of book materials stored on cabinet, for example.

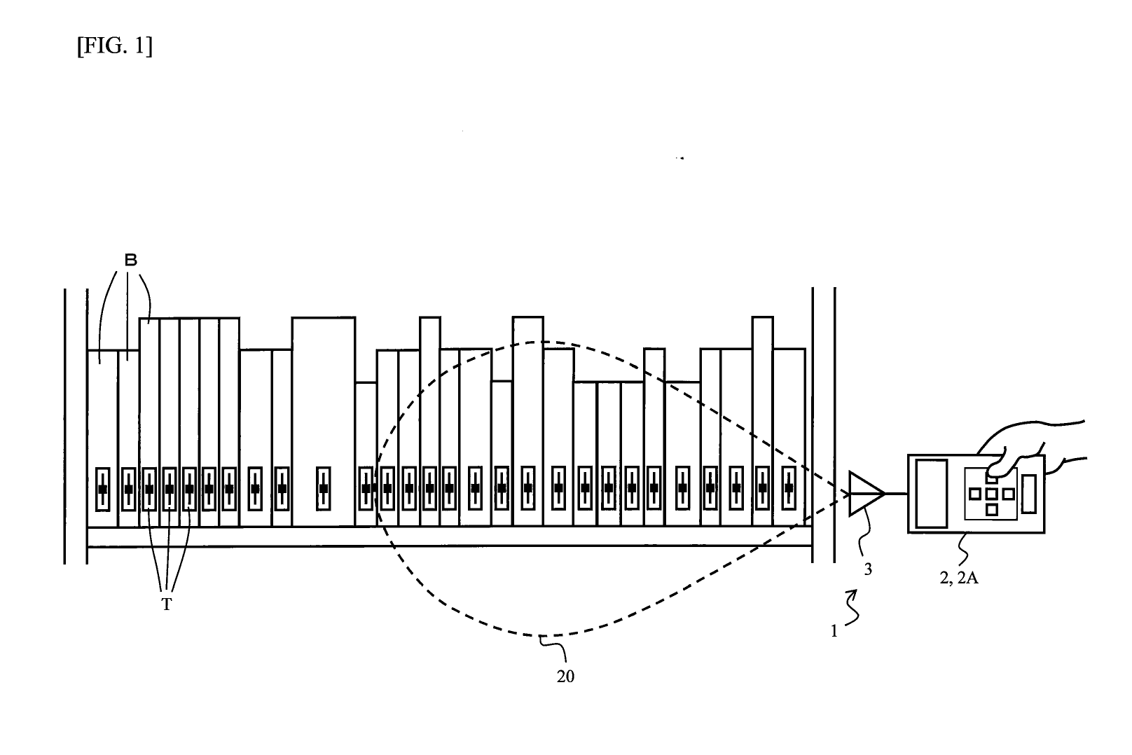

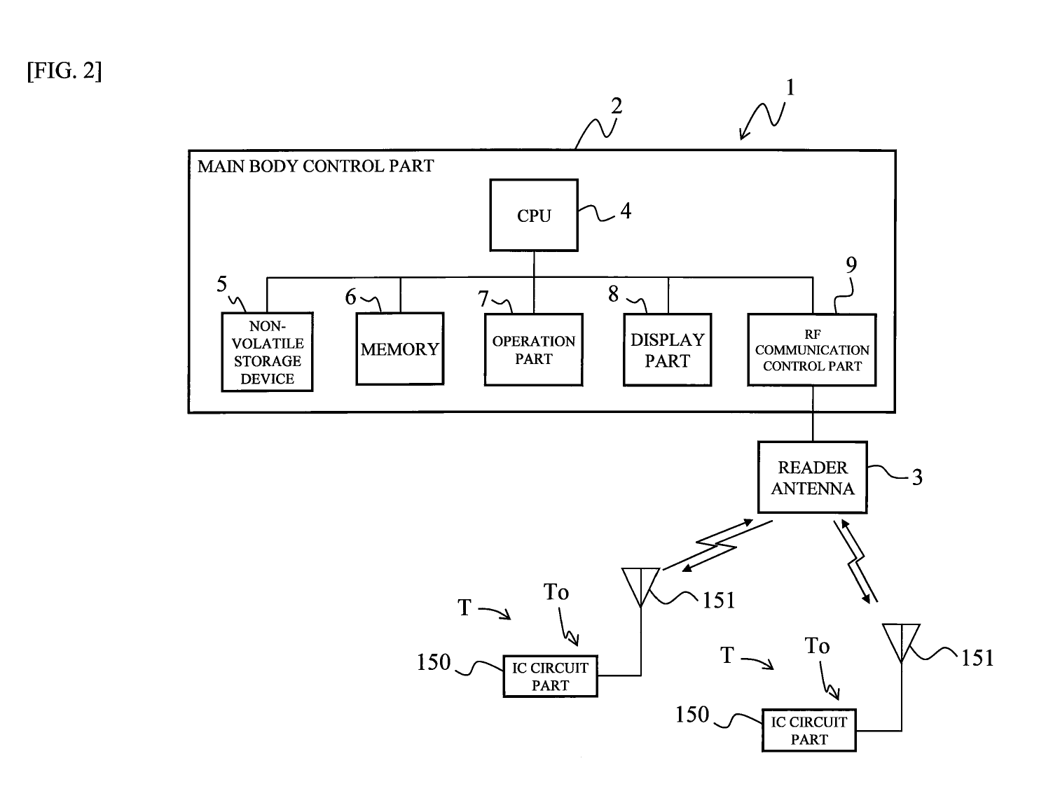

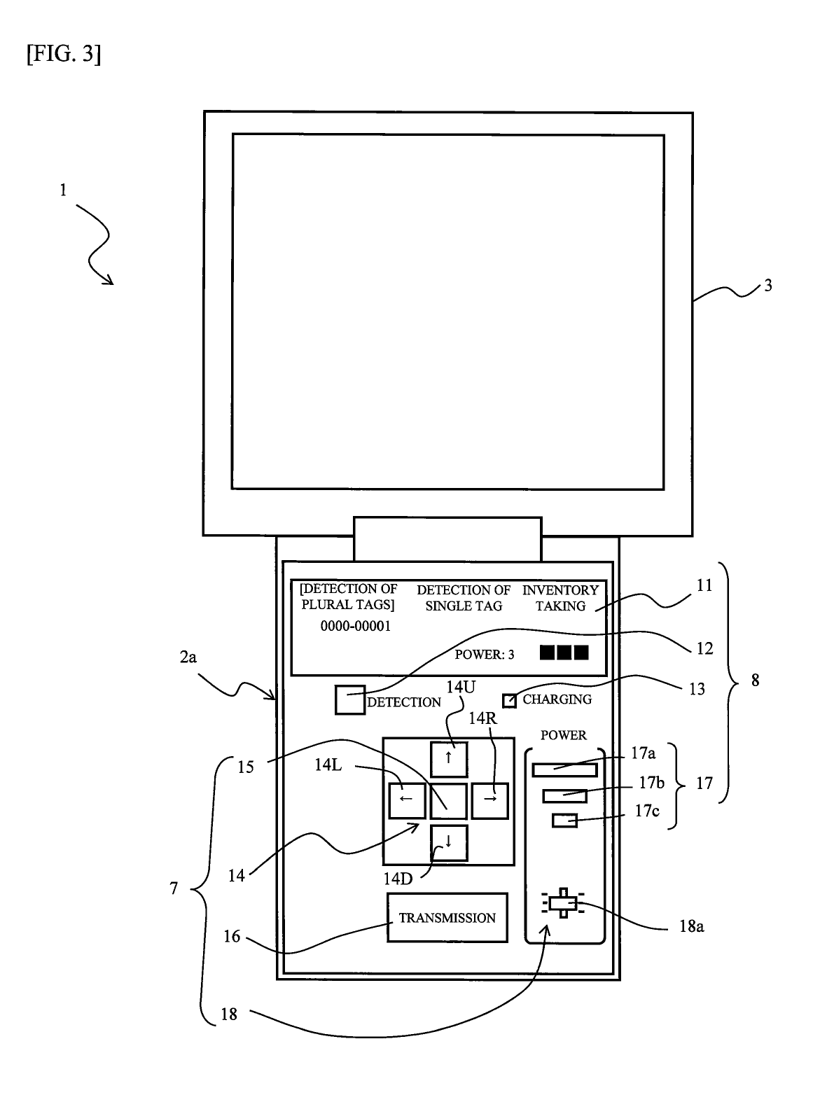

In FIG. 1, in this embodiment, a plurality of articles or a plurality of book materials B in this example are stored on a single shelf in a cabinet. Each of the plurality of book materials B has a vertical attitude with a longitudinal direction of its spine label placed in a perpendicular direction, and the plurality of book materials B are aligned in a horizontal direction (right and left direction in the figure). The RFID tag T is attached to the spine label of each book material B. A reader 1, which is an apparatus for communicating with an RFID tag of this embodiment is a handheld communication device. On a housing of the reader 1, an operation part 7 and a display part 8 (See FIGS. 2 and 3, respectively, which will be described later) are provided.

A user of the reader 1 is a person who is taking out the book material B. The user makes input setting of a list of the book materials B in the reader 1 in advance through the operation part. The material to be taken out may be one or plural. Alternatively, the input setting may be made from another terminal or information equipment via wired communication through a USB cable, for example, or radio communication such as wireless LAN. The user takes the reader 1 in hand and moves the reader 1 from one side end portion to the other side end portion of a row of the plurality of book materials B aligned in the horizontal direction as above. As a result, the reader 1 transmits and receives information to or from the RFID tag T attached to each book 11 via radio communication and searches a placed position of each book material B set in the list.

A communicable area 20 of the reader 1 shown by a broken line in the figure is an area spread from the reader antenna 3 as a base point. A range of the communicable area 20 is limited by directivity of a reader antenna 3 or output power. The output power is power, that is, so-called aerial power. The reader 1 determines availability of reception of identification information from the RFID tag T of the targeted book material B while changing the communicable area 20 in a stepped manner. As a result, the reader 1 can detect a distance from the reader 1 to the targeted book material B and search an approximate placed position on the shelf plate.

In FIG. 2, the reader 1 reads information stored in the RFID tag T from the RFID tag T attached to each book material B via radio communication.

The reader 1 has a main body control part 2 and the reader antenna 3. The main body control part 2 has a CPU 4, a non-volatile storage device 5 such as a hard disk device or a flash memory, a memory 6, the operation part 7, the display part 8, and a radio frequency (RF) communication control part 9. The reader antenna 3 and the RF communication control part 9 constitute a radio communication device. The non-volatile storage device 5 stores information relating to all the book materials B. The memory 6 includes a RAM and a ROM, for example. In the operation part 7, an instruction and information from the user is inputted. The display part 8 displays various kinds of information and messages. The RF communication control part 9 controls radio communication with the RFID tag T through the reader antenna 3.

The CPU 4 executes signal processing according to a program stored in the ROM in advance using a temporary storage function of the RAM so as to perform various control of the entire reader 1.

The RFID tag T has an RFID tag circuit element To provided with a tag antenna 151 and an IC circuit part 150. The RFID tag circuit element To is disposed on a base material, not particularly shown, so as to construct the RFID tag T. The RFID tag T can be attached to an article such as the book material B. The RFID tag circuit element To will be described later in detail.

In FIG. 3, the reader 1 integrally includes a housing 2a of the main body control part 2 and the reader antenna 3. The housing 2a is formed substantially in a rectangular solid. The reader antenna 3 is disposed at one end portion of the housing 2a in the longitudinal direction or an upper end portion in an illustrated example. The communicable area 20 of the reader 1 is formed along the directivity of the reader antenna 3 and to extend on a longitudinal extension of the housing 2a from the reader antenna 3 (upward direction in FIG. 2) in this example. Thus, in a use example shown in FIG. 1, the user performs search processing while holding the housing 2a in hand and directing the reader antenna 3 toward the plurality of the book materials B.

On a plane on one side (a face on the illustrated front side) of the housing 2a, a liquid crystal panel 11, a detection lamp 12, a charging lamp 13, four direction keys 14U, 14D, 14L, 14R, a determination key 15, a transmission key 16, a power indicator 17, and a transmission intensity adjusting slider 18 are disposed. The liquid crystal panel 11 is arranged on an upper side in the figure. The detection lamp 12 and the charging lamp 13 are arranged on a lower side in the figure of the liquid crystal panel 11. The four direction keys 14U, 14D, 14L, 14R are arranged in a cross shape substantially at the center position in the figure. The determination key 15 is arranged at the center of the direction keys 14U, 14D, 14L, 14R. The transmission key 16 is arranged on the lower side of the figure. The power indicator 17 is arranged on the right side of the direction keys 14U, 14D, 14L, 14R. The transmission intensity adjusting slider 18 is arranged on the right side of the transmission key 16. The four direction keys 14U, 14D, 14L, 14R, the determination key 15, the transmission key 16, and the transmission intensity adjusting slider 18 constitute the operation part 7. The liquid crystal panel 11, the detection lamp 12, the charging lamp 13, and the power indicator 17 constitute the display part 8.

The liquid crystal panel 11 displays switching states of various types of functions executed by the reader 1 and various kinds of information and messages in these functions in letters and symbols. Also, the liquid crystal panel 11 displays a charged state of a battery (not particularly shown) of the reader 1 by means of an indicator. In the illustrated example, three modes of functions, that is, “plural tag detection function”, “single tag detection function” and “inventory-taking function” are prepared. The illustrated example displays a state in which the “plural tag detection function” has been selected. Also, the illustrated example displays a state in which the battery charged state is “3” in three stages and three square frames are painted.

In processing executed by the single tag detection function, the reader 1 specifies only one RFID tag T or the book material B to which the RFID tag T is attached. Then, the reader 1 executes the “single tag detection mode”, which will be described later and continues communication to inquire if there is the specified RFID tag T in a range of the maximum communicable area of the reader 1 or not all the time. At this time, with respect to the specified single RFID tag T, the reader 1 determines availability of radio communication with the RFID tag T in each stage while changing the communicable area 20 from the minimum range to the maximum range. As a result, the reader 1 detects the minimum communicable area capable of radio communication and detects an approximate separation distance from the reader 1 to the RFID tag T on the basis of a power corresponding to the minimum communicable area.

The plural tag detection function executes the “plural tag detection mode”, which will be described later, and the “single tag detection mode”. That is, first, in the plural tag detection mode, the plurality of RFID tags T or corresponding plurality of book materials B are sequentially specified. Then, the reader 1 continues to communicate so as to inquire if there is the RFID tag T in a range of the maximum communicable area of the reader 1 or not all the time. At this time, a detection tag list listing identification information of the specified plurality of RFID tags T (hereinafter referred to as a tag ID) is prepared in advance. The reader 1 confirms that the RFID tag T of the book material B corresponding to each tag ID described in the detection tag list is present in the range of the maximum communicable area of the reader 1, respectively. After that, the mode is switched to the single tag detection mode, and the reader 1 executes the processing similar to the single tag detection function to each RFID tag T. That is, the reader 1 specifies only one RFID tag T or the book material B to which the RFID tag T is attached in the detection tag list. Then, the reader 1 continuously performs communication to inquire if the RFID tag T is present or not in the range of the maximum communicable area of the reader 1 while changing the specified RFID tag T. As a result, the reader 1 detects a placed position of each RFID tag T on the shelf plate, that is, a separation distance from the reader 1 to each RFID tag T. Detailed contents of the plural tag detection mode and the single tag detection mode will be described later in more detail.

The processing executed by the inventory-taking function is processing to read the tag IDs of only those plurality of RFID tags T specified in advance in order to determine only if they can be detected or not. In this processing, since only presence of the tag matters, the processing is finished at the time when all the tag IDs of the specified plurality of RFID tags T have been read.

Also, in FIG. 3, the detection lamp 12 and the charging lamp 13 are both display function parts using light-emitting elements such as an LED. The detection lamp 12 displays presence of detection of the specified RFID tag T by a difference between being lighted and not lighted. The charging lamp 13 displays a charged state of the battery by a difference between being lighted and not lighted.

Also, the power indicator 17 includes LEDs 17a, 17b, 17c, which are three light-emitting elements aligned vertically in the figure in this example. The power indicator 17 displays magnitude of the power in a stepped manner or three steps in the illustrated example by the number of lighted LEDs 17a to 17c.

Also, the four direction keys 14U, 14D, 14L, 14R arranged in a cross shape are press-in type key switches. The direction keys 14U, 14D, 14L, 14R are assigned capable of directing vertical and horizontal directions corresponding to a positional relation to the center of the cross arrangement, respectively. The direction keys 14U, 14D, 14L, 14R are used for a movement instruction of a cursor displayed on the liquid crystal panel 11 or a selection instruction of a plurality of options. Also, the determination key 15 arranged at the center of the four direction keys 14U, 14D, 14L, 14R is used for a determination instruction of such a selection.

Also, the transmission key 16 is a key switch used to instruct start of transmission of various instruction commands and information to the RFID tag T.

Also, the transmission intensity adjusting slider 18 is a slider-type switch that can move a position of a knob 18a vertically in the figure in a stepped manner. The user can make fine adjustment of the intensity and power of a radio wave outputted from the reader antenna 3 using this.

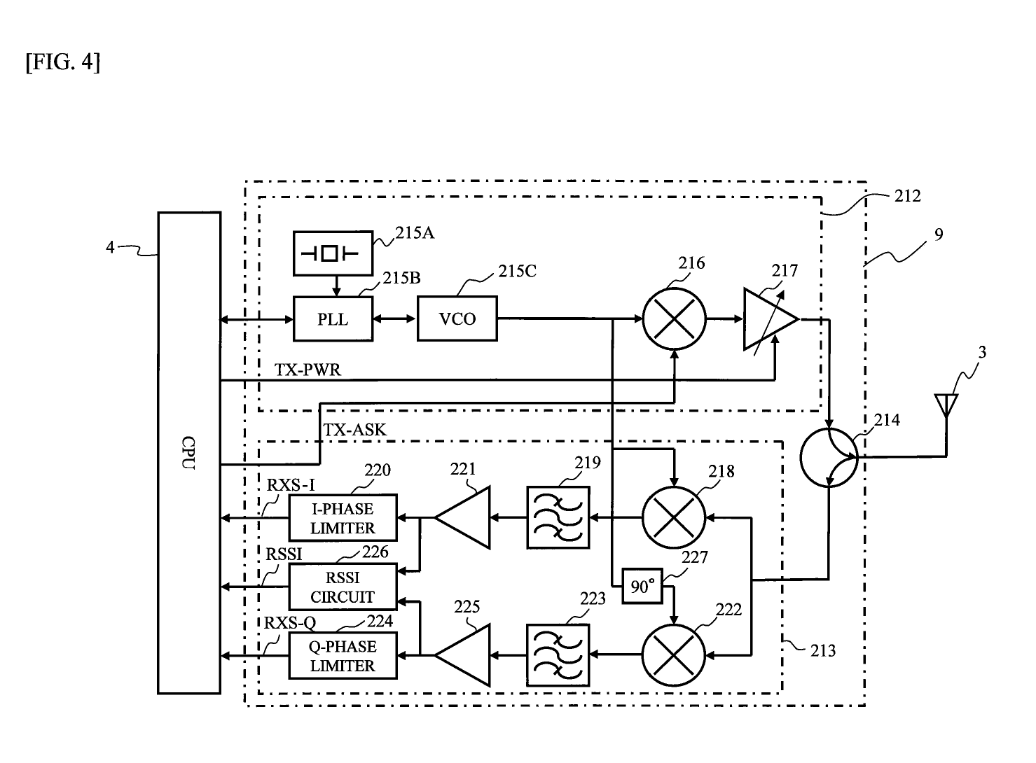

In FIG. 4, the RF communication control part 9 accesses information containing the tag ID stored in the IC circuit part 150 of the RFID tag circuit element To through the reader antenna 3.

The CPU 4 processes a signal read of the IC circuit part 150 of the RFID tag circuit element To so as to read information and also generates various commands to access the IC circuit part 150 of the RFID tag circuit element To. The details will be described later.

The RF communication control part 9 includes a transmitting portion 212, a receiving portion 213, and a transmit-receive splitter 214.

The transmitting portion 212 is a block configured to generate an interrogation wave to access RFID tag information of the IC circuit part 150 of the RFID tag circuit element To through the reader antenna 3. The transmitting portion 212 is provided with a crystal oscillator 215A, a Phase Locked Loop (hereinafter referred to as a “PLL”) 215B, a Voltage Controlled Oscillator (hereinafter referred to as a “VCO”) 215C, a transmission multiplying circuit 216, and a variable transmission amplifier 217.

The crystal oscillator 215A outputs a reference signal of a frequency. The PLL 215B generates a carrier wave with a predetermined frequency by dividing and multiplying an output of the crystal oscillator 215A by means of control of the CPU 4. The VCO 215C outputs a carrier wave with a frequency determined based on a control voltage generated by the PLL 215B. As the frequency of the generated carrier wave, a UHF band, a micro wave band or a short-wave band frequency, for example, is used.

The transmission multiplying circuit 216 modulates the carrier wave generated based on the signal supplied from the CPU 4. In this example, the transmission multiplying circuit 216 executes amplitude modulation on the basis of a “TX_ASK” signal from the CPU 4. In the case of such amplitude modulation, an amplification rate variable amplifier, for example, may be used instead of the transmission multiplying circuit 216.

The variable transmission amplifier 217 amplifies the modulated wave modulated by the transmission multiplying circuit 216. In this example, the variable transmission amplifier 217 performs amplification with an amplification rate determined by a “TX_PWR” signal from the CPU 4. The output of the transmission amplifier 217 is transmitted to the reader antenna 3 through the transmit-receive splitter 214, radiated from the reader antenna 3 as an interrogation wave and supplied to the IC circuit part 150 of the RFID tag circuit element To. The interrogation wave is not limited to the modulated signal, that is, the modulated wave as above, but the wave might be a simple carrier wave.

The receiving portion 213 receives an input of a response wave from the RFID tag circuit element To received by the reader antenna 3. The receiving portion 213 is provided with an I-phase receiving signal multiplying circuit 218, an I-phase band-pass filter 219, an I-phase receiving signal amplifier 221, an I-phase limiter 220, a phase shifter 227, a Q-phase receiving signal multiplying circuit 222, a Q-phase band-pass filter 223, a Q-phase receiving signal amplifier 225, a Q-phase limiter 224, and a Received Signal Strength Indicator (hereinafter referred to as an “RSSI”) circuit 226 as strength detecting device.

The I-phase receiving signal multiplying circuit 218 multiplies and demodulates the response wave from the RFID tag circuit element To received by the reader antenna 3 and inputted through the transmit-receive splitter 214 and the generated carrier wave.

The I-phase band-pass filter 219 takes out only a signal in a required band from the output of the I-phase receiving signal multiplying circuit 218. The I-phase receiving signal amplifier 221 amplifies an output of the I-phase band-pass filter 219. The I-phase limiter 220 further amplifies the output of the I-phase receiving signal amplifier 221 and converts it to a digital signal.

The phase shifter 227 delays a phase of the carrier wave generated as above by 90°. The Q-phase receiving signal multiplying circuit 222 multiplies the response wave from the RFID tag circuit element To received at the reader antenna 3 and the carrier wave whose phase is delayed by the phase shifter 227 by 90°. The Q-phase band-pass filter 223 takes out only a signal in a required band from the output of the Q-phase receiving signal multiplying circuit 222. The Q-phase receiving signal amplifier 225 amplifies an output of the Q-phase band-pass filter 223. The Q-phase limiter 224 further amplifies the output of the Q-phase receiving signal amplifier 225 and converts it to a digital signal.

A signal “RXS-I” outputted from the I-phase limiter 220 and a signal “RXS-Q” outputted from the Q-phase limiter 224 are inputted into the CPU 4 and processed. The outputs from the I-phase receiving signal amplifier 221 and the Q-phase receiving signal amplifier 225 are also inputted into the RSSI circuit 226 and a signal “RSSI” indicating the intensity of these signals is inputted into the CPU 4. As above, the reader 1 demodulates the response wave from the RFID tag circuit element To by I-Q quadrature demodulation.

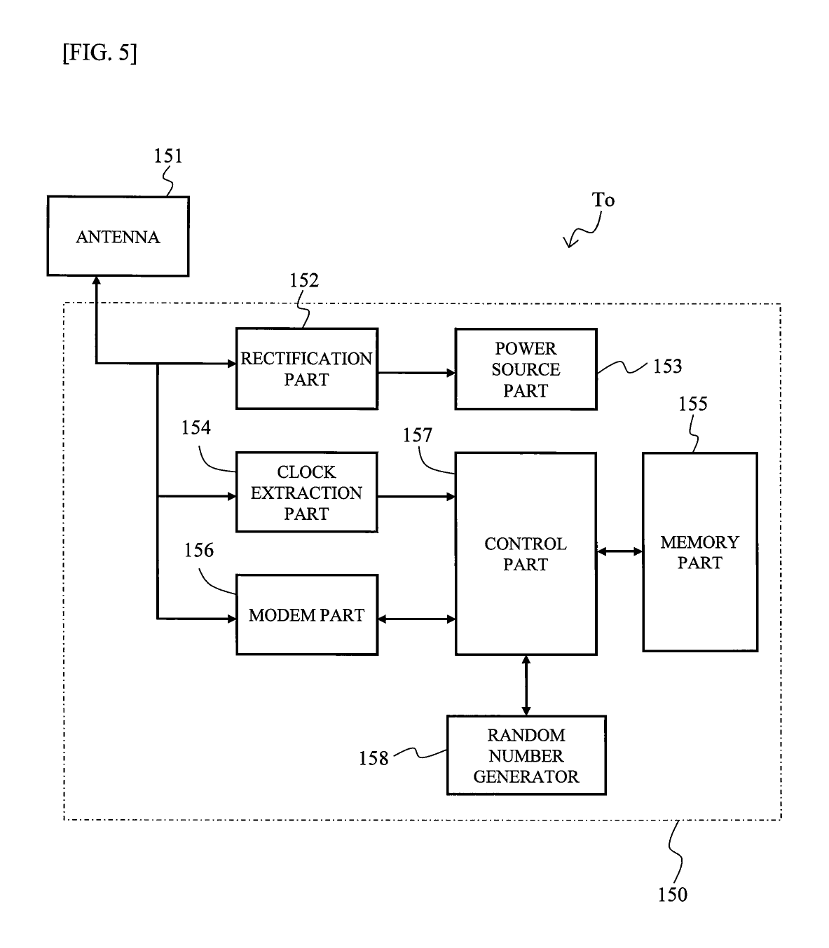

In FIG. 5, the RFID tag circuit element To has the tag antenna 151 performing transmission and reception of a signal in a non-contact manner with the reader antenna 3 of the reader 1 as described above and the IC circuit part 150 connected to the tag antenna 151.

The IC circuit part 150 is provided with a rectification part 152, a power source part 153, a clock extraction part 154, a memory part 155, a modem part 156, a random number generator 158, and a control part 157. The rectification part 152 rectifies an interrogation wave received by the tag antenna 151. The power source part 153 accumulates energy of the interrogation wave rectified by the rectification part 152 and uses the energy as a driving power source of the RFID tag circuit element To. The clock extraction part 154 extracts a clock signal from the interrogation wave received by the tag antenna 151 and supplies the signal to the control part 157. The memory part 155 stores a predetermined information signal. The random number generator 158 generates a random number when the interrogation wave as an interrogation signal from the reader 1 is received. To which identification slot a response wave as a response signal should be outputted is determined by the random number. The interrogation signal and identification slot will be described later. The control part 157 controls operations of the RFID tag circuit element To through the memory part 155, the clock extraction part 154, the random number generator 158, and the modem part 156, for example.

The modem part 156 demodulates an interrogation wave from the reader antenna 3 of the reader 1, received by the tag antenna 151. The modem part 156 also modulates a reply signal from the control part 157 and transmits it as a response wave, that is, a signal including the tag ID, from the tag antenna 151.

The clock extraction part 154 extracts a clock component from the received signal and supplies a clock corresponding to a frequency of the clock component to the control part 157.

The random number generator 158 generates a random number from 0 to 2^{Q}−1 to a slot number specified value Q specified in the interrogation signal from the reader 1. The details will be described later.

The control part 157 interprets a received signal demodulated by the modem part 156 and generates a reply signal on the basis of the information signal stored in the memory part 155. Then, the modem part 156 transmits the reply signal through the tag antenna 151 in an identification slot corresponding to the random number generated by the random number generator 158.

In the memory part 155, a tag ID uniquely set as identification information to specify an individual RFID tag circuit element To is stored in advance.

Here, the most distinctive characteristic of the reader 1 of this embodiment is processing contents in the plural tag detection function to search the respective arrangement positions of the plurality of RFID tags T. That is, in this processing, it is first checked in the plural tag detection mode if the plurality of RFID tags T to be searched are present in a range of the maximum communicable area of the reader 1, respectively, or not. After that, in the single tag detection mode, the RFID tag T whose presence was confirmed is specified, and the arrangement position of the RFID tag T is searched individually. The details will be sequentially explained below.

First, a signal transmitted and received between the reader 1 and the RFID tag T and a method of transmission and reception thereof will be described using the international standard ISO/IEC 18000-6 Type C protocol as an example.

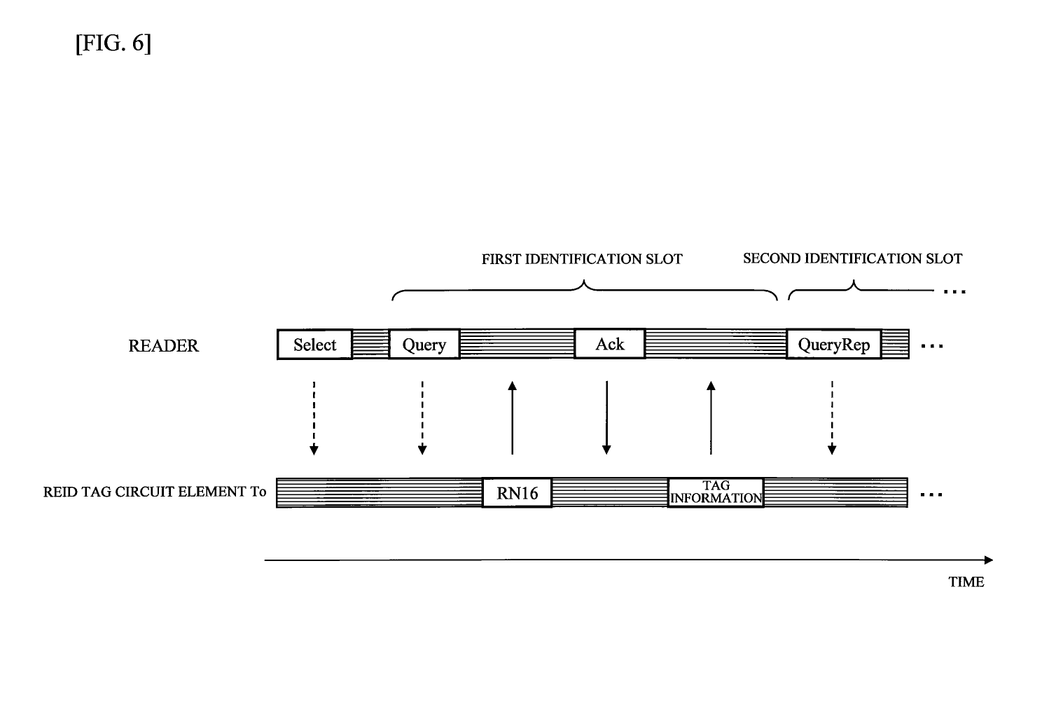

The method of transmitting and receiving a signal shown in FIG. 6 is based on the known Slotted Random method. A change over time from the left side to the right side is shown in the figure. Also, arrows shown between the reader 1 and the RFID tag T indicate a transmission direction of the signal. If the other party of transmission is unspecified, that is shown by a broken line, while if the other party of transmission is specified, that is shown by a solid line.

In FIG. 6, the reader first transmits a “Select” command to all the RFID tags T present in the communicable area 20. This “Select” command is a command to specify a condition of the RFID tag T with which the reader 1 conducts radio communication after that. By this “Select” command, various conditions are specified and the number of RFID tags T whose information is to be read is limited so that efficiency of the radio communication can be improved. Only the RFID tag T satisfying the specified conditions in the RFID tags T having received the “Select” command can conduct radio communication after that. In the figure, only one RFID tag circuit element To satisfying the conditions is shown.

Subsequently, the reader 1 transmits a “Query” command as a reading command to request response transmission of the respective tag information to the same RFID tag group. The tag information includes a tag ID, which is identification information. This “Query” command includes a slot number specified value Q to specify any of values from 0 to 15 in this example. If the “Query” command is transmitted from the RF communication control part 9 through the reader antenna 3, each of the RFID tag circuit elements To of the RFID tag T having received the command creates random numbers from 0 to 2^{Q}−1, that is, up to Q power of 2−1 by the random-number generator 158 and maintains them as slot count values S.

Immediately after transmitting the “Query” command through the reader antenna 3, the reader 1 waits for a response from the RFID tag circuit element To in a predetermined identification slot. This identification slot is a timeframe divided in a predetermined period after the “Query” command or a “QueryRep” command, which will be described later, is first transmitted. This identification slot is usually repeated continuously for a predetermined number of times. For example, a single session of a first identification slot of the “Query” command and 2^{Q}−1 sessions of a second identification and after of the “QueryRep” command, totaling in 2^{Q} times, are repeated.

Then, as in the illustrated example, the RFID tag circuit element To having created a value 0 as the slot count value S responds in the first identification slot containing this “Query” command. At this time, the RFID tag circuit element To transmits an “RN16” command using a pseudo random number of 16 bits, for example, in order to obtain permission to transmit the tag information to the reader 1 as a response signal.

Then, the reader 1 having received the “RN16” command transmits an “Ack” command to permit transmission of the tag information with the contents corresponding to the “RN16” command. The RFID tag circuit element To having received the “Ack” command determines if the received “Ack” command corresponds to the “RN16” command transmitted by the RFID circuit element To before. If it is determined that the “RN16” command corresponds to the “Ack” command, the RFID tag circuit element To considers that the transmission of its own tag information is permitted and transmits the tag information containing the tag ID. As described above, transmission and reception of a signal in a single identification slot is performed.

After that, the second identification slot and after transmits the “QueryRep” command instead of the “Query” command. Then, the reader 1 waits for a response of the other RFID tag circuit elements To (not particularly shown) in the identification slot timeframe provided immediately after that. Each RFID tag circuit element To having received the “QueryRep” command subtracts its own slot count value S only by 1 and maintains the value. Each RFID tag circuit element To conducts transmission and reception of a signal including the “RN16” command with the reader 1 in the identification slot at the time when the slot count value S becomes a value 0.

In each identification slot, if there is no RFID tag circuit element To with the slot count value S of 0, transmission and reception is not conducted except the “Query” command or “QueryRep” command. After a predetermined timeframe has elapsed, the identification slot is finished.

As described above, each RFID tag circuit element To replies a response signal in a different identification slot. As a result, the reader 1 is not affected by interference but can clearly receive and take in the tag information of the respective RFID tag circuit elements To.

Subsequently, a registration tag list recorded in the non-volatile storage device 5 of the reader 1 and a detection tag list created based on that will be described.

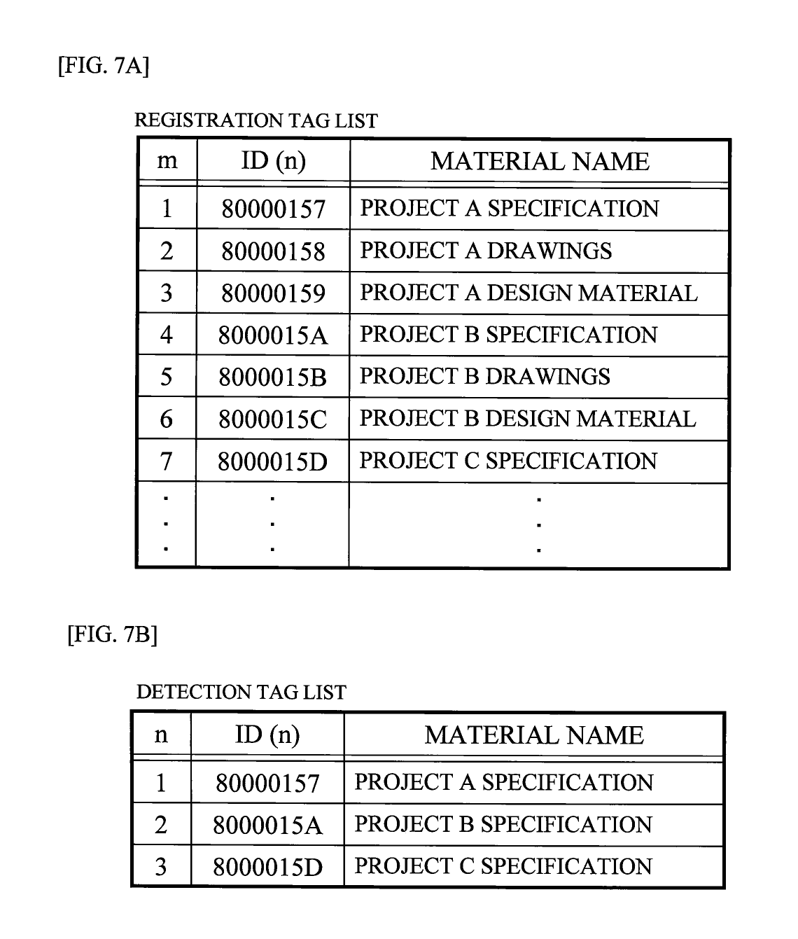

In FIG. 7A, in the registration tag list, names of all the book materials B placed in the cabinet (See FIG. 1) and tag IDs of the RFID tags T attached to them are registered in association with reference numbers m, respectively. This list is prepared for each cabinet in advance and recorded and stored in the non-volatile storage device 5 of the reader 1 as described above, for example.

Then the user of the reader 1 selects and extracts the book material B to be searched in the registration tag list corresponding to the cabinet as a preparation stage for searching a placed position of the plurality of RFID tags T corresponding to each of the plurality of book materials B using the plural tag detection function. As a result, the detection tag list as shown in FIG. 7B is created. In the illustrated example, only specifications of projects A, B, C are selected and extracted as search targets. The respective material names and tag IDs are contained in the detection tag list in a form of correlation information associated with the reference numbers n. The created detection tag list is stored in the memory 6, for example. Alternatively, it may be held and stored in the non-volatile storage device 5. The memory 6 or the non-volatile storage device 5 constitutes a storage device.

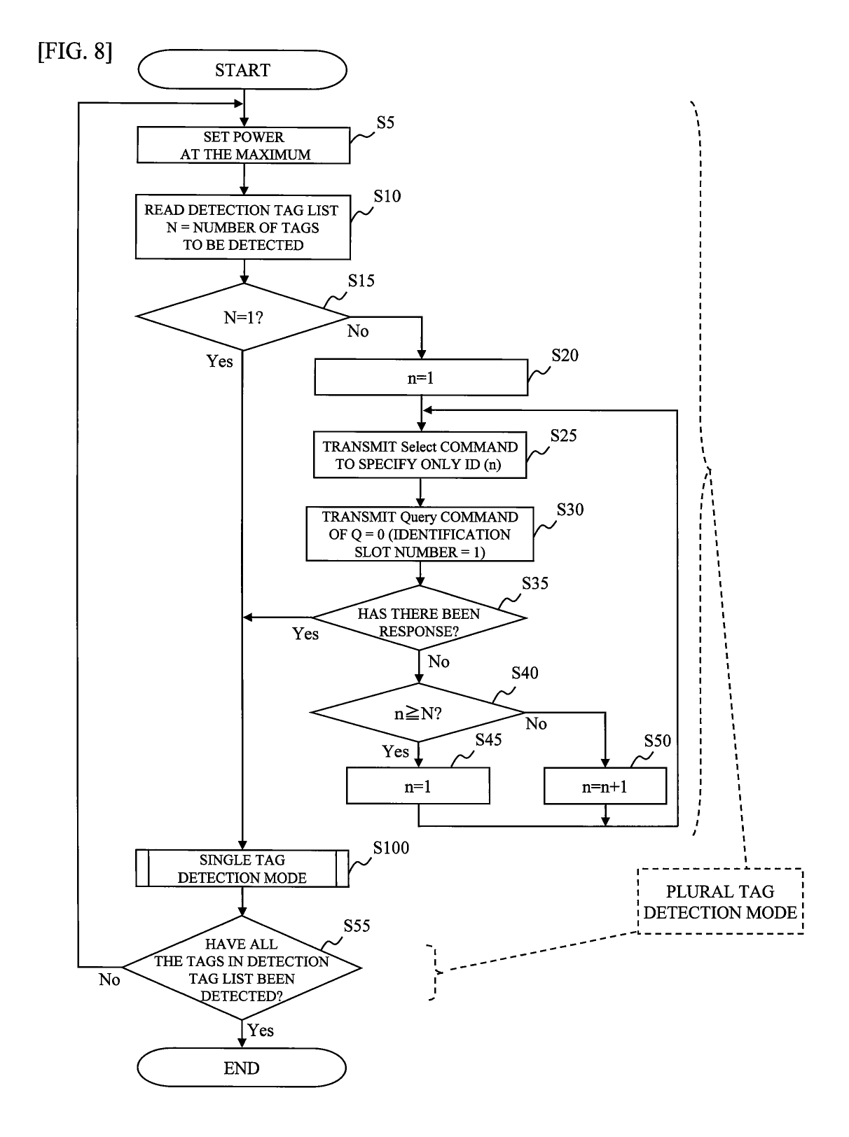

In FIG. 8, in this example, the search tag list (See FIG. 7B) is created in advance, and when the transmission key 16 is pressed down in a state in which the plural tag detection function is selected, this flow is started.

First at Step S5, the CPU 4 outputs a control signal to the RF communication control part 9 so as to set the intensity of the power at the maximum. Specifically, the CPU 4 outputs the “TX_PWR” signal to the RF communication control part 9 with the maximum value, maximizes an amplification rate in the variable transmission amplifier 217 and executes control so that output intensity of a radio wave transmitted from the reader antenna 3 becomes the maximum (See FIG. 4). As a result, radio communication is enabled to all the RFID tags T present in the range of the maximum communicable area of the reader 1. In the example shown in FIG. 1, radio communication is enabled to the RFID tags T attached to each of all the book materials B arranged on the shelf plate.

Subsequently, the routine goes to Step S10, and the CPU 4 reads the detection tag list from the memory 6 or the non-volatile storage device 5. Then, the CPU 4 sets the number of the book materials B or the tag IDs recorded in the detection tag list as a value of a variable N. The number of the book materials B or the tag IDs is the maximum value of the reference number n in other words and it is 3 in the example shown in FIG. 7B. Then, the routine goes to the subsequent Step S15.

At Step S15, the CPU 4 determines if the value of the variable N is 1 or not. In other words, the CPU 4 determines if the number of the RFID tags T to be searched, that is, the number of book materials B recorded in the detection tag list is only one or not. If the value of N is 2 or more, that is, if there are a plurality of the RFID tags T to be searched, the determination is not satisfied, and the routine goes to the subsequent Step S20.

At Step S20, the CPU 4 sets the value of a variable n corresponding to the reference number of the detection tag list to 1 and goes to the subsequent Step S25.

Then, at Step S25, the CPU 4 generates the “Select” command to specify only the tag ID with the reference number corresponding to the value of the variable n in the detection tag list and transmits it through the reader antenna 3. In the figure and the description below, the tag ID corresponding to the value of n is noted as “ID(n)”. As a result, in the RFID tag T attached to the book materials B arranged in the cabinet, only the RFID tag T whose ID(n) is stored in the memory part 155 of the RFID tag circuit element To can conduct radio communication after that. That is, the RFID tag T with the ID(n) and the reader 1 can perform information transmission and reception on a one-on-one basis.

Then, the routine goes to Step S30, and the CPU 4 generates a “Query” command with the slot number specified value Q of 0 and transmits it through the reader antenna 3. If the slot number specified value Q is set to 0 as above, because of 2^{Q}=1, the number of identification slots is only one. Also, the RFID tag circuit element To with the ID(n) having received this “Query” command generates the value 0 as the slot count value S because of 2^{Q}−1=0. As a result, the RFID tag T with the ID(n) transmits the “RN16” command as a response signal to the reader 1 in the first identification slot immediately after the tag receives the “Query” command with the slot number specified value Q=0. Then, the RFID tag T with the ID(n) continues transmission and reception of the “Ack” command and “tag information including tag ID” (See FIG. 6 for the above).

As described above, the procedures of Step S25 and Step S30 are performed. As a result, even with the Slotted Random method using the “Select” command and the “Query” command, confirmation of presence of the RFID tag T and transmission and reception of information can be performed only for a single specific RFID tag T, that is, the RFID tag T with the ID(n) in the large number of RFID tags T in the shortest time, that is, with one identification slot number.

Then, the routine goes to the subsequent Step S35, and the CPU 4 determines if a response signal, that is, the “RN16” command, for example, has been received or not to the “Query” command transmitted at Step S30. In other words, the CPU 4 determines if there has been a response from the RFID tag T whose tag ID is the ID(n) or not. If there has been no response, here, the determination is not satisfied, that is, it is considered that there is no RFID tag T with the ID(n) in a range of the maximum communicable area of the reader 1 or that the radio communication at Step S25 and Step S30 has failed, and the routine goes to the subsequent Step S40.

At Step S40, the CPU 4 determines whether or not the value of the variable n is the value of the variable N or more. If the value of the variable n is the value of the variable N or more, the determination is satisfied. In this case, the CPU 4 considers that no response is obtained from the ID(n) recorded in the detection tag list even if it is sequentially called by the “Query” command or that the communication has failed. Then, the CPU 4 returns the value of the variable n to 1 at Step S45. After that, the routine returns to Step S25 and repeats the similar procedure, and the CPU 4 conducts radio communication again from the first RFID tag T.

On the other hand, if the value of the variable is smaller than the value of the variable N, the determination at Step S40 is not satisfied. That is, the CPU 4 increments the value of the variable n by one at Step S50. After that, the routine returns to Step S25, and the CPU 4 conducts radio communication to the subsequent RFID tag T in the detection tag list.

Also, on the other hand, in the determination at Step S35, if there is a response from the RFID tag T with the ID(n), the determination at Step S35 is satisfied. That is, the CPU 4 considers that presence of the RFID tag T with the ID(n) in the range of the maximum communicable area of the reader 1 can be confirmed, and the routine goes to the single tag detection mode at Step S100.

Also, on the other hand, in the determination at Step S15, if the value of N is 1, that is, if there is only one RFID tag T to be searched, the determination is satisfied. That is, the CPU 4 considers that there is no need to confirm presence of the individual RFID tags T by the procedures at Step S20 to Step S50, and the routine goes to the single tag detection mode at Step S100 without a change.

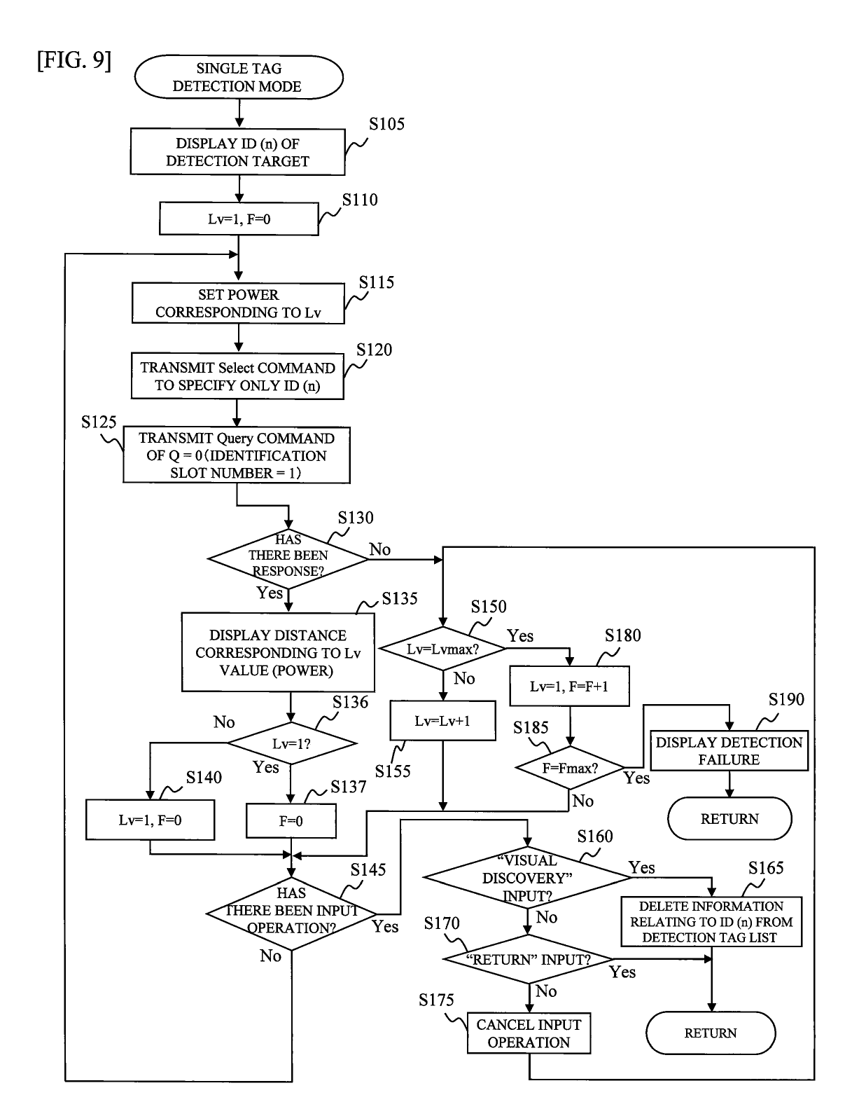

As described above, in the single tag detection mode at Step S100 moved from Step S15 or Step S35, the CPU 4 detects a separation distance from the RFID tag T to the reader 1 by conducting radio communication with the RFID tag T with the ID(n) (See FIG. 9, which will be described later).

Subsequently, the routine goes to Step S55, and the CPU 4 determines if detection of the arrangement position in the single tag detection mode at Step S100, that is, detection of the separation distance from the reader 1 has been performed or not for all the ID(n) stored in the detection tag list. If there remains the ID(n) for which detection of the arrangement position has not been performed, the determination is not satisfied, and the routine returns to Step S5 and the similar procedure is repeated. On the other hand, if the detection of the arrangement position has been already performed for all the ID(n) stored in the detection tag list, the determination is satisfied, and this flow is finished.

In the procedures of the flow shown in FIG. 8, Step S5 to Step S50 and Step S55 except Step S100 correspond to the plural tag detection mode described in each claim.

By performing the procedures in the above flow, if only one ID(n) is stored in the detection tag list, the reader 1 immediately detects the arrangement position of the RFID tag T corresponding to the ID(n) in the single tag detection mode. If a plurality of ID(n) are stored in the detection tag list, the reader 1 confirms if the RFID tags T corresponding to the respective ID(n) are present in the range of the maximum communicable area of the reader 1 or not. Then, the reader 1 detects the arrangement position only for the RFID tag T whose presence was confirmed in the single tag detection mode.

At Step S105 shown in FIG. 9, the CPU 4 outputs a control signal to the display part 8 so as to display the contents of the ID(n) to be searched on the display part 8. After that, at the subsequent Step S110, the CPU 4 initializes a value of a variable Lv corresponding to a level of the power to the minimum and initializes the value of a variable F corresponding to the number of failure times of detection to 0. If the variable Lv is changed in 10 steps of Lv=1 to 10, for example, the CPU 4 initializes Lv to 1 at this Step S110.

Subsequently, the routine goes to Step S115, and the CPU 4 sets intensity of the power of the reader 1 corresponding to the value of the variable Lv. Specifically, similarly to the procedure at Step S5 in the flow of FIG. 8, the “TX_PWR” signal corresponding to the value of the variable Lv is outputted to the RF communication control part 9 so as to control the amplification rate in the variable transmission amplifier 217. As a result, corresponding to the change of the variable Lv in 10 steps from 1 to 10, the power of the reader 1 is also controlled to be increased and decreased in 10 steps. In the above example, the power becomes the maximum when the variable Lv=10. In the case immediately after the variable Lv is initialized to 1 at Step S110, the power of the reader 1 is set to the lowest intensity, and the power of the reader 1 is increased corresponding to increase of the variable Lv.

Then, at the subsequent step S120, the CPU 4 transmits the “Select” command to specify only the ID(n) from the reader antenna 3. After that, the CPU 4 transmits the “Query” command with the slot number specified value Q of 0 from the reader antenna 3 at Step S125. In the procedures at Step S120 and Step S125, the same control as in the procedures at Step S25 and Step S30 in the flow of FIG. 8, respectively, is executed. By these two procedures, the reader 1 makes a call via radio communication only with the RFID tag T with the ID(n) in the shortest time, that is, gives a response request.

At the subsequent Step S130, similarly to the procedure at Step S35 in the flow of FIG. 8, the CPU 4 determines if there has been a response from the RFID tag T with the ID(n) or not. If there has been a response, the determination is satisfied. In this case, the CPU 4 considers that there is the RFID tag T with the ID(n) in the range of the communicable area 20 of the reader 1 corresponding to the power of the variable Lv at that point of time. After that, the routine goes to the subsequent Step S135.

At Step S135, the CPU 4 calculates the separation distance from the reader 1 corresponding to the variable Lv at the point of time by a predetermined calculation. This function of the CPU 4 constitutes a position detection portion. Then, the CPU 4 displays the distance as a numeral value, for example, on the display part 8. This function of the CPU 4 constitutes an alarm portion. In this display of the separation distance, the longest distance of the communicable area 20 of the reader 1 formed by the power corresponding to the variable Lv, that is, the separation distance from the reader antenna 3 to the distal end of the communicable area 20 is displayed. In other words, the display shows a range from the reader 1 where there is a possibility that the RFID tag T with the ID(n) is present.

Subsequently, the routine goes to Step S136, and the CPU 4 determines if the value of the variable Lv has become 1 or not. If this determination is not satisfied, the routine goes to Step S140, and the CPU 4 subtracts the value of the variable Lv by 1. Alternatively, the CPU 4 may subtract the variable value by another value such as 2. The CPU 4 also sets the value of the variable F to 0. After that, the routine goes to Step S145, which will be described later. If Step 5136 is satisfied, the CPU 4 sets the value of the variable F to 0 again at Step 5137. After that, the routine goes to Step S145, which will be described later.

Also, on the other hand, in the determination at Step S130, if there has been no response from the RFID tag T with the ID(n), the determination is not satisfied. In this case, the CPU 4 considers that there is no RFID tag T with the ID(n) in the range of the communicable area 20 of the reader 1 corresponding to the power of the variable Lv at that point of time. After that, the routine goes to Step S150.

At Step S150, the CPU 4 determines if the value of the variable Lv is equal to a maximum value Lvmax or 10 in this example. If the value of the variable Lv is different from the maximum value Lvmax, that is, if the Lv is smaller than the maximum value Lvmax and has not reached the maximum value, the determination is not satisfied. In this case, the CPU 4 increments the value of the variable Lv by 1 at the subsequent Step S155. After that, the routine goes to Step S145.

At Step S145, the CPU 4 determines if there has been any input operation from a user operating the reader 1 through the operation part 7 or not. If there has been no input operation, the determination is not satisfied, and the routine returns to Step S115 and repeats the similar procedure.

On the other hand, in the determination at Step S145, if there has been some input operation in the operation part 7, the determination is satisfied, and the routine goes to Step S160.

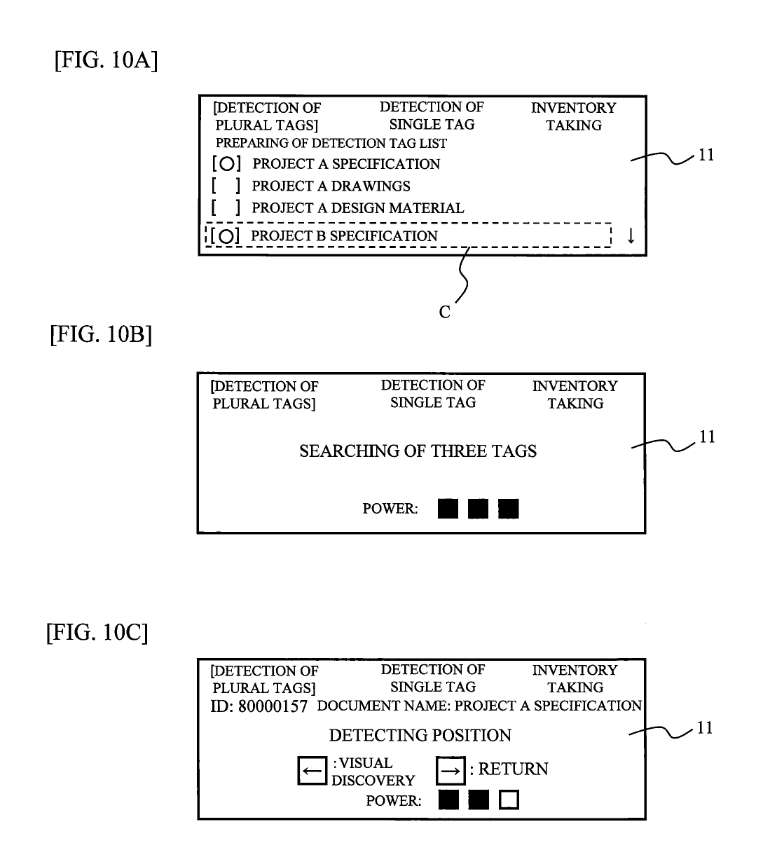

At Step S160, the CPU 4 determines if the input operation detected at Step S145 is an input operation corresponding to “visual discovery” or not. The visual discovery here means that the user has visually found the book material B to be searched by referring to display of the detection position of the RFID tag T at Step S135, for example. That is, in the single tag detection mode, the reader 1 repeats radio communication even after the arrangement position of the RFID tag T with the ID(n) is detected and displayed. However, if the position is found as above, since the object is achieved for this RFID tag T, it is no longer necessary to search the arrangement position of the RFID tag T with the ID(n) by the reader 1. Therefore, in order to stop the single tag detection mode for detecting the RFID tag T with the ID(n), it is configured such that the user can make a corresponding input operation as indication of intention by the user (See FIG. 10C, which will be described later). If the input operation corresponding to the “visual discovery” is made, the determination at Step S160 is satisfied, and at Step S165, the CPU 4 deletes information relating to the ID(n) from the detection tag list or the ID(n) and the material name in this example, and this flow is finished. As a result, the single tag detection mode is finished, and the mode is changed to the plural tag detection mode in FIG. 8, and the reader 1 can resume search of the subsequent RFID tag T for the remaining RFID tags T for which the tag IDs remains in the detection tag list. On the other hand, if there has been no input operation corresponding to the “visual discovery”, the determination is not satisfied, and the routine goes to the subsequent Step S170.

At Step S170, the CPU 4 determines if the input operation detected at Step S145 is an input operation to finish the single tag detection mode, that is, an input operation corresponding to “RETURN” to return to the plural tag detection mode or not. That is, it is configured such that even if the detection operation is repeated for a long time without radio communication with the RFID tag T with the ID(n), the user can make the input operation of “RETURN” as indication of intension in order to give up detection of the RFID tag T and to arbitrarily return to the plural tag detection mode.

If the input operation corresponding to “RETURN” has been made, the determination at Step S170 is satisfied, and this flow is finished. That is, the routine goes to Step S55 in FIG. 8. At this time, the CPU 4 returns to the plural tag detection mode in FIG. 8 in a state in which the tag ID of the corresponding RFID tag T remains in the detection tag list. As a result, while the tag ID is not deleted but kept in the detection tag list since the RFID tag T or the book material B as a target has not been found yet, the search can be continued in the plural tag detection mode for another RFID tag T. This is because there is a possibility that position detection processing will be performed again for the targeted RFID tag T or book material B at another chance. Also, if the user loses the RFID tag T after switching to the single tag detection mode, the search can be made again from the plural tag detection mode.

On the other hand, if the input operation corresponding to the “RETURN” has not been made, the determination is not satisfied, and the routine goes to the subsequent Step S175. At Step S175, the CPU 4 cancels the input operation detected at Step S145. After that, the routine goes to Step S150.

Also, on the other hand, in the determination at Step S150, if the value of the variable Lv is equal to the maximum value Lvmax or 10 in this example, that is, if the value of the variable Lv has reached the maximum value, the determination is satisfied, and the routine goes to Step S180.

At Step S180, the CPU 4 re-sets the value of the variable Lv to 1 and increments the value of the variable F by 1. As a result, it means that the reader 1 could not detect the RFID tag T with the ID(n) even after the reader 1 has changed the power corresponding to the variable Lv sequentially in all the stages once and conducted communication with the maximum output at Lv=10. As a result, the number of failure times F at the maximum power is incremented by 1.

At the subsequent Step S185, the CPU 4 determines if the value of the variable F corresponding to the number of failure times is equal to the value of the maximum value Fmax or not. If the value of the variable F is different from the maximum value Fmax and is smaller than the maximum value Fmax, that is, if the value of the variable F has not reached the maximum value, the determination is not satisfied, and the routine goes to Step S145.

On the other hand, if the value of the variable F is equal to the maximum value Fmax, that is, if the value of the variable F has reached the maximum value, the determination at Step S185 is satisfied. In this case, at the subsequent Step S190, the CPU 4 displays the fact that detection of the RFID tag T with the ID(n) has failed on the display part 8 and then, this flow is finished. That is, in this example, if a predetermined time has elapsed after the reader 1 started communication for position detection in the single tag detection mode, the mode is automatically switched to the plural tag detection mode by a determination procedure at Step S185. At this switching, the tag ID of the corresponding RFID tag T is left in the detection tag list. For the RFID tag T or book material B for which the communication for position detection continues after the predetermined time has elapsed, it might be a case in which the corresponding RFID tag T or book material B has moved and left the communication range, for example. Therefore, the CPU 4 considers that a disadvantage due to loss of time is larger even if the position detection is continued. Then, since the tag ID has not been found yet, the tag ID is not deleted but left in the list, and the reader 1 continues the search in the plural tag detection mode for another RFID tag T. This is because there is a possibility that position detection processing will be performed again at another chance for the RFID tag T or book material B for which the communication for position detection is taking time.

By performing the procedures in the flow as above, only one RFID tag T with the ID(n) is searched, and the its separation distance from the reader 1 is displayed on the display part 8. When the “visual discovery” or “RETURN” input operation is made by the user, this flow is finished. If the book material B to which the RFID tag T with the ID(n) to be searched is attached has been taken out or a predetermined time has elapsed since radio communication consecutively fails for a long time due to deterioration of the wave environment, for example, this flow is also finished.

When the operator starts a search, if the single tag detection function is selected and the transmission key 16 is pressed down instead of pressing down on the transmission key 16 while the plural tag detection function is selected as above, only the flow in FIG. 9 is executed. In this case, if Step S190 is finished, the processing is also finished at that point.

In FIG. 10, all the display examples of the liquid crystal panel 11 use a case in which the plural tag detection function is selected.

In FIG. 10A, on the liquid crystal panel 11, a part of the material names registered in the registration tag list are enumerated. In the illustrated example, the user can move the cursor C by pressing and operating the two direction keys 14U and 14D as selection operating devices. The direction keys 14U and 14D constitute the selection operating devices. The cursor C is shown by a square frame by a broken line in the figure. The user can also display other material names by keeping on moving the cursor C. Then, when the user presses the determination key 15 as the selection operating device when the name of the material to be searched is surrounded by the cursor C, the material name and the corresponding tag ID are selected and extracted from the registration tag list. Then, the extracted material name and the tag ID are stored and held in the search tag list. As described above, the detection tag list is created by the operation performed by the user.

In the display example shown in FIG. 10B, a state in which the power substantially corresponds to the maximum output state is displayed, and three painted square frames are displayed.

In the display example shown in FIG. 10C, an example is shown that a position of the RFID tag T attached to the book material B of “project A specification” with the tag ID of “80000157” is being detected. In the illustrated example, the power is in the output state in the “2” stage indicating an approximate medium intensity, and two painted square frames are displayed.

Also, in this example, the direction key 14L as a first operating device corresponding to the left direction corresponds to the above-described “visual discovery”. If the user presses down the direction key 14L in the illustrated display state, information corresponding to the “project A specification” is deleted (See Step S165 in FIG. 9) from the detection tag list, and the routine goes to Step S55 in FIG. 8.

Also, in this example, the direction key 14R as a second operating device corresponding to the right direction corresponds to the above-described “RETURN”. If the user presses down the right direction key 14R in the illustrated display state, the routine goes to Step S55 in FIG. 8.

In the above, the procedures at Step S25, Step S30, and Step S35 in the flow in FIG. 8 constitute an information obtaining portion.

Also, the procedures at Step S110, Step S115, Step S140, Step S155, and Step S180 in the flow of FIG. 9 constitute output control portions. Also, the procedure at Step 5150 constitutes a first determination portion.

Also, the procedures at Step S15 and Step S35 in the flow of FIG. 8 and the procedures at Step S160, Step S170, and Step S185 in the flow of FIG. 9 constitute mode switching portions. Also, the procedure at Step S165 in the flow of FIG. 9 constitutes a deletion processing portion.

As described above, in the reader 1 of this embodiment, by means of the procedures at Step S20 to Step S50 in the flow of FIG. 8, first, communication for search is conducted on the basis of at least specified one tag ID, and if there is a response from the RFID tag T with the specified tag ID, the information is obtained. After that, the RFID tag T having responded is specified, communication for position detection is made by the procedure in the flow of FIG. 9, and the position of the RFID tag T is detected on the basis of the communication result.

As described above, instead of the position detection of the RFID tag T from the beginning, first, a search is made to see if there is an RFID tag T to give a response or not and if there is a response, the RFID tag T is specified and position detection is performed individually. As a result, even if there are a plurality of RFID tags T as targets, the position of each RFID tag T can be detected efficiently in a short time.

At this time, particularly only if the determination at Step S35 is satisfied, the single tag detection mode at Step S100 is executed, and since the single tag detection mode can be omitted for the RFID tag T without a response at Step S35, entire processing efficiency can be reliably improved.

In this embodiment, particularly in the procedure at Step S135 in the flow of FIG. 9, the position information detected in the single tag detection mode, that is, a display alarm according to an estimated distance is made. As a result, the user can reliably recognize a distance from the reader 1 to the RFID tag T to be detected visually.

In the example of this embodiment, a distance is displayed on the liquid crystal panel 11 as a numeral value, but visual display such as display of a length of a bar graph with respect to the prescribed scales can be made other than the above. As a mode of the alarm, other than the display alarm to be visually recognized as described above, sound alarm to be acoustically recognized or vibration alarm to be haptically recognized can be also used. The sound alarm includes an alarm using a difference in tone such as pitch of sound or width of pulse sound, for example. The vibration alarm includes an alarm using a difference in amplitude of the vibration or frequency, for example.

Also, particularly in this embodiment, the power when the plural tag detection mode is performed to make a search to see if there is an RFID tag T to give a response or not is set larger than the power of the subsequent single tag detection mode so that a wider communication range is realized and as many responses from the RFID tags T as possible can be detected.

Also, particularly in this embodiment, the power is increased and decreased in a stepped manner by the procedure at Step S155 in FIG. 9. As a result, at Step S130, a position where the communication for position detection is barely possible, that is, the communication would not be possible if the output is smaller than that is detected. As a result, a distance from the reader 1 to the RFID tag T can be reliably estimated (See Step S135 in FIG. 9).

Also, particularly in this embodiment, the power corresponding to a predetermined distance range from the reader 1, that is, an output corresponding to the variable Lvmax is set as a threshold value. If the communication for position detection is not successful up to the power corresponding to the threshold value Lvmax, the CPU 4 considers that there is no RFID tag T as a position detection target in the distance range. As a result, the fact can be alarmed to the user (See Step S190 in FIG. 9).

In the embodiment, the power for transmission of a response request signal such as the “Query” command from the reader 1 to the RFID tag T is changed in a stepped manner. By determining presence of a response from the RFID tag T in each stage, a position of the RFID tag T is detected from the separation distance from the reader 1 corresponding to the power in each stage. However, the present invention is not limited to this method. That is, the position of the RFID tag T may be detected on the basis of received signal intensity when the response signal transmitted from the RFID tag T is received by the reader 1, for example.

In this case, the “RSSI” signal inputted from the RSSI circuit 226 into the CPU 4 in the receiving portion 213 of the RF communication control part 9 indicates the received signal intensity. The larger the distance from the reader 1 to the RFID tag T becomes, the smaller the received signal intensity from the RFID tag T, that is, a level of the “RSSI” signal becomes. Therefore, by detecting the received signal intensity by the RSSI circuit 226 in the communication for position detection, a distance to the RFID tag T can be estimated.

At this time, if the communication for position detection is conducted at a predetermined power, which is a fixed value, for example, from the reader 1, the received signal intensity usually obtained at a position with a distance relatively close to the reader 1 is set by the reader 1 as a threshold value. Then, when the communication for position detection is conducted at the power of the predetermined value, it is determined by the CPU 4 if the received signal intensity detected by the RSSI circuit 226 is less than the predetermined threshold value or not. This determination function of the CPU 4 constitutes a second determination portion. If the detected received signal intensity is smaller than the threshold value, the CPU 4 considers that there is no RFID tag T as a position detection target in the distance range, that is, the tag is relatively far. As a result, the PCU 4 can inform the user of the fact.

Also, particularly in this embodiment, if the number of tag IDs included in the detection tag list is one, the mode is switched to the single tag detection mode at Step S15 in the flow of FIG. 8. If there is only one piece of identification information in the detection tag list, there is no need to go through two stages of search first and then, position detection. Therefore, by executing the single tag detection mode immediately as above, more efficient position detection can be realized.

Also, particularly in this embodiment, by operating the operation key for movement and selection and determination of the cursor C, a tag ID for communication for search can be selected and extracted in the plural tag detection mode in the plurality of tag IDs included in the registration tag list. In the example of this embodiment, operation with the two direction keys 14U and 14D corresponding to the vertical direction and the determination key 15 corresponds to the above-described operation.

That is, the user does not necessarily want to search all the RFID tags T whose tag IDs are described in the registration tag list. Therefore, by enabling selection and input of a part of the registration tag list in the detection tag list, and in the procedure at Step S20 to Step S50 in the flow of FIG. 8, communication for search is conducted only for the RFID tags T with the tag IDs inputted in the detection tag list as search targets. As a result, convenience for the user can be further improved.

Also, in this embodiment, presence of the tag is determined only by presence of a response from a target tag to the “Query” command, but not limited to that. That is, the “RN16” responded from the target tag to the “Query” command is received, and the “Ack” command permitting transmission of the tag information with the contents corresponding to the “RN16” command is transmitted. After that, it may be so configured that the tag information of the RFID tag circuit element To including the tag ID is received and presence of the target tag is determined from the tag ID. If this method is used, though time required for the communication is increased, determination accuracy on presence of the tag and the distance to the tag is improved.

The “Select” command, the “Query” command, the “RN16” command, the “Ack” command, and the “QueryRep” command, for example, used in the above shall comply with the specification formulated by EPC global. The EPC global is a non-profit corporation jointly established by International EAN Association, which is an international organization of distribution codes, and Uniformed Code Council (UCC), which is an U.S. distribution code organization. Signals complying with other standards will do as long as they serve the same functions.

Other than those described above, methods of the embodiments and each variation may be combined as appropriate for use.

Though not specifically exemplified, the present invention should be put into practice with various changes made in a range not departing from its gist.

What is claimed is:

1. An apparatus for communicating with a radio frequency identification (RFID) tag comprising:
a radio communication device configured to conduct radio communication with a plurality of RFID tag circuit elements, the RFID circuit element having an IC circuit part storing information and a tag antenna capable of transmission and reception of the information;
an information obtaining portion configured to specify identification information of at least one said RFID tag circuit element to be searched and to conduct communication for search through said radio communication device so as to obtain information from said IC circuit part of said RFID tag circuit element thus specified; and
a position detection portion configured to conduct communication for position detection through said radio communication device with the specific RFID tag circuit element whose information was obtained by said information obtaining portion and to detect a position of the specified RFID tag circuit element on the basis of a communication result of the communication for position.

2. The apparatus according to claim 1, further comprising
an output control portion configured to set intensity of a power of said radio communication device when the position detection is performed by said position detection portion at intensity of the power or less of said radio communication device when said information is obtained by said information obtaining portion.

3. The apparatus according to claim 2, wherein:
said output control portion can control intensity of the power in a stepped manner; and
said position detection portion detects a position of said RFID tag circuit element on the basis of a communication result of the communication for position detection when the intensity of the power is increased and decreased by said output control portion in the stepped manner.

4. The apparatus according to claim 3, further comprising
a first determination portion configured to determine whether the power of said output control portion becomes larger than a predetermined threshold value or not.

5. The apparatus according to claim 1, wherein:
said radio communication device has an intensity detecting device configured to detect signal intensity received from said RFID tag circuit element; and
said position detection portion detects a position of said RFID tag circuit element on the basis of a detection result of said intensity detecting device in said communication for position detection.

6. The apparatus according to claim 5, further comprising
a second determination portion configured to determine whether the signal intensity detected by said intensity detecting device is less than a predetermined threshold value or not.

7. The apparatus according to claim 3, further comprising
an alarming device configured to give at least any one of display alarm, sound alarm, and vibration alarm according to position information detected by said position detection portion.

8. The apparatus according to claim 7, further comprising:
a storage device configured to store a list of identification information of a plurality of said RFID tag circuit elements as the search targets; and
a mode switching portion capable of switching a mode into a plural tag detection mode or a single tag detection mode, a plural pieces of identification information being sequentially specified so that the communication for search is conducted by said information obtaining portion in the plural tag detection mode, the plural pieces of information being in said list stored in said storage device, the communication for position detection being conducted by said position detection portion in the single tag detection mode by specifying one of the identification information in said list.

9. The apparatus according to claim 8, further comprising
a first operating device capable of operating and inputting that an RFID tag circuit element to be searched or an article relating to the RFID tag circuit element to be searched has been found by an operator on the basis of the alarm by said alarm portion when a mode has been switched into said single tag detection mode by said mode switching portion.

10. The apparatus according to claim 9, further comprising
a deletion processing portion configured to, when an operation input is made by said first operating device, delete the identification information of the RFID tag circuit element from said list of said storage device, the identification information corresponding to the operation input, wherein
said mode switching portion switches said single tag detection mode into said plural tag detection mode when the operation input is made by said first operating device.

11. The apparatus according to claim 9, further comprising
a second operating device capable of operating and inputting that discovery of an RFID tag circuit element to be searched or an article relating to the RFID tag circuit element to be searched is given up by said operator when a mode has been switched to said single tag detection mode by said mode switching portion.

12. The apparatus according to claim 11, wherein:
when an operation input is made by said second operating device, said mode switching portion switches said single tag detection mode into said plural tag detection mode with leaving the identification information of the RFID tag circuit element corresponding to the operation input in said list of said storage device.

13. The apparatus according to claim 8, wherein:
after the mode is switched into said single tag detection mode and said communication for position detection is started by said position detection portion, said mode switching portion switches the mode into said plural tag detection mode with leaving the identification information of the RFID tag circuit element corresponding to the position detection in said list of said storage device, in the case that a state in which a response from the RFID tag circuit element corresponding to the position detection has not been obtained continues for a predetermined time.

14. The apparatus according to claim 8, wherein:
said mode switching portion switches the mode to said single tag detection mode in the case that the number of pieces of said identification information included in said list stored by said storage device is one.

15. The apparatus according to claim 8, further comprising
a selection operating device capable of selecting and inputting identification information among the plural pieces of identification information included in said list, for which said communication for search is to be conducted in said plural tag detection mode, wherein
said information obtaining portion conducts said communication for search using, as a search target, said RFID tag circuit element for which said identification information is selected by said selection operating device.
